(19) United States
(12) Patent Application Publication
(10) Pub. No.: US 2021/0117809 A1
(43) Pub. Date: Apr. 22, 2021

(54) AI GUIDED SPECTRUM OPERATIONS

(71) Applicant: Parsons Corporation, Centreville, VA (US)

(72) Inventors: Joseph Payton, Centreville, VA (US); Samantha Palmer, Centreville, VA (US)

(73) Assignee: Parsons Corporation, Centreville, VA (US)

(21) Appl. No.: 17/068,142

(22) Filed: Oct. 12, 2020

Related U.S. Application Data
(60) Provisional application No. 62/915,746, filed on Oct. 16, 2019.

(51) Int. Cl. G06N 5/02; G06N 20/00; G06F 16/23

(52) U.S. Cl. CPC G06N 5/02; G06F 16/2379; G06N 20/00

(57) ABSTRACT

An intelligent hierarchal agent structure responds to requests and inquires regarding a data environment by parsing the query to actionable sub-questions and assigning each to a primary agent. Upon examination of available data, the agent assesses whether the sub-question can be resolved or whether additional material is needed. In the later instance the agent seeks aid from subordinate or secondary agents which in turn seek aid of other agents in order to generate information as necessary to resolve to the question presented. Upon resolution of the question the output is placed in a common database which is continually monitored by each agent. Agents are engaged in parallel yet respond according to a hierarchal structure.

### RELATED APPLICATION

The present application relates to and claims the benefit of priority to U.S. Provisional Patent Application No. 62/915,746 filed 16 Oct. 2019 which is hereby incorporated by reference in its entirety for all purposes as if fully set forth herein.

### BACKGROUND OF THE INVENTION

### Field of the Invention

Embodiments of the present invention relate, in general, to intelligent decision making and more particularly to decision systems guided by artificial intelligence and machine learning.

### Relevant Background

From autonomous vehicles to autonomous markets, it is becoming increasingly clear that solutions comprised of autonomous intelligent agents are changing the way we get things done. In situations involving “person-in-the-loop” style systems (where computer decision making is constantly being verified and checked by the human operator), we continue to push the human operator out of the tighter, faster inner loops and into a more supervisory role. This push from the center is for good reason: for what autonomous systems lack in ingenuity, they make up for in untiring and unrelenting attention and speed.

More importantly, recent advances in the field of machine learning empower computer systems to “discover” hidden insights within data, exposing hidden correlations and conclusions normally obscured by the complexity and enormity of the available data. This allows for the creation of tools that act as a force multiplier, allowing the benefit of the properties of large data sets while providing the human decision maker on the other end with a higher level of understanding of the meaning of its contents.

No field is in more need of the advantages of machine learning than signal detection and analysis. Signal detection requires the capturing and analysis of vast amounts of data and even a simple task can overwhelm the most experienced analyst. What is needed is a system that pairs machine learning with the various disciplines within the field of data science to serve as a true force multiplier for spectrum operations. A need exists for automation of the attention intensive tasks of detection, identification, classification and location of Radio Frequency (RF) emitters and the like that will lead to faster, better insights in order to provide actionable decision support information. These and other deficiencies of the prior art are addressed by one more embodiments of the present invention.

Additional advantages and novel features of this invention shall be set forth in part in the description that follows, and in part will become apparent to those skilled in the art upon examination of the following specification or may be learned by the practice of the invention. The advantages of the invention may be realized and attained by means of the instrumentalities, combinations, compositions, and methods particularly pointed out in the appended claims.

### SUMMARY OF THE INVENTION

The present invention utilizes established, predetermined protocols, to deconstruct or parse a query within a distinct domain. Depending on the scope of the question or the area of interest, a deconstruction agent analyzes an inquiry and parses the question into one more sub-questions. Upon resolution of each sub-question the deconstruction agent combines each response and resolves the initial inquiry in the form of an output, report or the like.

To provide the information needed for the deconstruction agent to respond, a primary (intelligent) agent is assigned to each sub-question based on a predetermined protocol. The selection of a particular primary agent is centered on established processes and the nature of each sub-question. Examining data present in a common database, the primary agent assesses whether the current state of data is sufficient to resolve the sub-question or if additional information/data is required. In the case of the latter, the primary agent seeks assistance of a secondary agent.

Like the primary agent, the secondary agent receives the request and determines whether sufficient information is available to produce its response. If the data present in the database is sufficient, an output is created and stored in the database. The primary agent, monitoring the database, recognizes that the previous absence of data and corresponding request has been resolved and acts accordingly. Should the secondary agent also need additional information a tertiary agent can be sought, and so forth, until each sub-question is resolved.

In one embodiment a system for intelligent spectrum operations includes a deconstruction agent, one or more primary agents and one or more secondary agents. The deconstruction agent is configured to receive a question and parse the question into one or more sub-questions based on a predetermined protocol while the one or more primary agents is configured to monitor a database to identify information in the database to resolve the sub-question. Responsive to information in the database being inadequate to resolve the sub-question, the primary agent initiates a request to a secondary agent for additional processes to generate material lacking in the database yet needed to resolve the sub-question.

The secondary agent is configured to receive the request from a primary agent and generate the material to resolve the assigned sub-question. The secondary agent generates an output responsive to the sub-question/request and places the output in the database for action by the primary and deconstruction agent. Recognize that the deconstruction agent, the primary agent and the secondary agent are each embodied as instructions in the form of software, stored on a non-transitory storage medium and executable by a processor.

Other features of the above described system include that the primary and secondary agents generate output using processes based on a predetermined protocol. Each agent is aware of other agent's abilities and each are engaged based on their ability. The structure is hierarchal, but flexible. Indeed, in one embodiment the deconstruction agent is a primary agent and in another embodiment a secondary agent can engage a primary agent.

In another instance of the present invention the primary agent is a classification agent and such an agent can be configured to translate input variables based on the predetermined protocol. In another embodiment the secondary agent is a feature extraction agent and is configured to conduct a mathematical or algorithmic process to generate the necessary output. And indeed, the secondary agent can also be a classification agent.

Another feature of the present invention is that the secondary agent is configured to monitor the database in search of information needed to resolve the sub-question and, responsive to information in the database being absent, the secondary agent is configured to request additional processes to generate needed additional material to resolve the assigned sub-question. To resolve the sub-questions, in one instance of the present invention, the secondary agent uses digital signal processing to generate the output while in another instance the secondary agent uses statistical and unsupervised means to generate the output.

As described above the system is a self-organizing top-down architecture to achieve intermediate stages so as to meet the request with the necessary output.

The invention for intelligent spectrum operations can also be implemented by a computer wherein the computer includes one or more processors configured to execute instructions stored on a non-transitory storage medium. The instructions to perform a method including receiving and parsing, by a deconstruction agent, a question into one or more sub-questions based on a predetermined protocol and thereafter selecting, for each sub-question, one of one or more primary agents.

The method continues by the selected one or more primary agents monitoring the database to identify information if the database includes information suitable to resolve the sub-question and, responsive to information in the database being inadequate to resolve the sub-question, sending a request for additional processes to generate the lacking material.

As result of the need, a secondary agent, receiving the request from the primary agent, generates material to resolve the sub-question placing the output in the database for discovery by the primary agent(s).

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

The aforementioned and other features and objects of the present invention and the manner of attaining them will become more apparent, and the invention itself will be best understood, by reference to the following description of one or more embodiments taken in conjunction with the accompanying drawings, wherein:

FIG. 1 shows a high-level block diagram of a system for artificial intelligence spectrum operations according to one embodiment of the present invention;

FIG. 2 shows system architecture and hierarchal layout of superior (primary) and inferior (secondary) agents for artificial intelligence spectrum operations according to one embodiment of the present invention;

FIG. 3 is an illustration of example of artificial intelligence spectrum operations with respect to the detection, classification and reporting of frequency agile radio frequency signals according to one embodiment of the present invention;

FIGS. 4A and 4B are detailed block diagrams of classification and feature extraction (primary and secondary) agents resolving a frequency agile radio frequency query, according to one embodiment of the present invention;

FIGS. 5A, 5B and 5C are communication flowcharts of an illustrative process for artificial intelligence spectrum operations according to one embodiment of the present invention;

FIG. 6 is a high-level block diagram of artificial intelligence spectrum operations according to one embodiment of the present invention showing interaction of primary and secondary agents in a standalone environment;

FIG. 7 is a high-level block diagram of artificial intelligence spectrum operations according to one embodiment of the present invention showing interaction of primary and secondary agents in an environment by which data and resources are shared; and

FIG. 8 is a high-level depiction of a computer system suitable for implementation of AI spectrum operations according to one embodiment of the present invention.

The Figures depict embodiments of the present invention for purposes of illustration only. Like numbers refer to like elements throughout. In the figures, the sizes of certain lines, layers, components, elements or features may be exaggerated for clarity. One skilled in the art will readily recognize from the following discussion that alternative embodiments of the structures and methods illustrated herein may be employed without departing from the principles of the invention described herein.

### DESCRIPTION OF THE INVENTION

The Artificial Intelligence (AI) Guided Spectrum Operations of the present invention provides a collaborative, multi (intelligent) agent system that continually optimizes system resources and observation opportunity in order to progressively refine user awareness of a defined domain. By engaging hardware, software, and data science expertise, the present invention provides functionality in tactical, compact form factors while remaining scalable to larger enterprise solutions.

The present invention utilizes established, predetermined protocols, to deconstruct or parse a query with a distinct domain. Depending on the scope of the question or the area of interest, a deconstruction agent analyzes an inquiry and parses the question into one more sub-questions. Upon resolution of each sub-question the deconstruction agent combines each response and resolves the initial inquiry in the form of an output, report or the like.

A primary (intelligent) agent is assigned to each sub-question based on a predetermined protocol. The selection of a particular primary agent is centered on established processes and the nature of the sub-question. Examining data present in a common database, the primary agent assesses whether the current state of data is sufficient to resolve the sub-question or if additional information/data is required. In the case of the latter the primary agent seeks assistance of a secondary agent.

Like the primary agent, the secondary agent receives the request and determines whether sufficient information is available to produce its response. If the data present in the database is sufficient, an output is created and stored in the database. The primary agent, monitoring the database, recognizes that data, previously lacking, has been resolved. Should the secondary agent also need additional information a tertiary agent can be sought, and so forth, until each sub-question is resolved.

Embodiments of the present invention are hereafter described in detail by way of example with reference to the accompanying Figures. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

The terminology used herein is for the purpose of describing particular embodiments only and is not intended to be limiting of the invention. As used herein, the singular forms “a,” “an” and “the” are intended to include the plural forms as well, unless the context clearly indicates otherwise. Thus, for example, reference to “a component surface” includes reference to one or more of such surfaces.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Unless otherwise defined below, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The term Artificial Intelligence (AI) is understood to mean a wide-ranging branch of computer science concerned with building smart machines capable of performing tasks that typically require human intelligence. AI is an interdisciplinary science with multiple approaches that makes it possible for machines to learn from experience, adjust to new inputs and perform human-like tasks. Using these technologies, computers can be trained to accomplish specific tasks by processing large amounts of data and recognizing patterns in the data.

The term Intelligent Agent is understood to mean a program that can make decisions or perform a service based on its environment, user input and experiences. It is an autonomous entity which acts, directing its activity towards achieving goals, upon an environment using observation through sensors and consequent actuators.

The term Protocol is understood to mean an official set of procedures for what actions to take in a certain situation. A protocol generally describes a plan or the documents that spell out such a plan or an agreement of how to proceed.

Included in the description are flowcharts depicting examples of the methodology which may be used for AI guided spectrum operations. In the following description, it will be understood that each block of the flowchart illustrations, and combinations of blocks in the flowchart illustrations, can be implemented by computer program instructions. These computer program instructions may be loaded onto a computer or other programmable apparatus to produce a machine such that the instructions that execute on the computer or other programmable apparatus create means for implementing the functions specified in the flowchart block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware-based computer systems that perform the specified functions or steps, or combinations of special purpose hardware and computer instructions.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

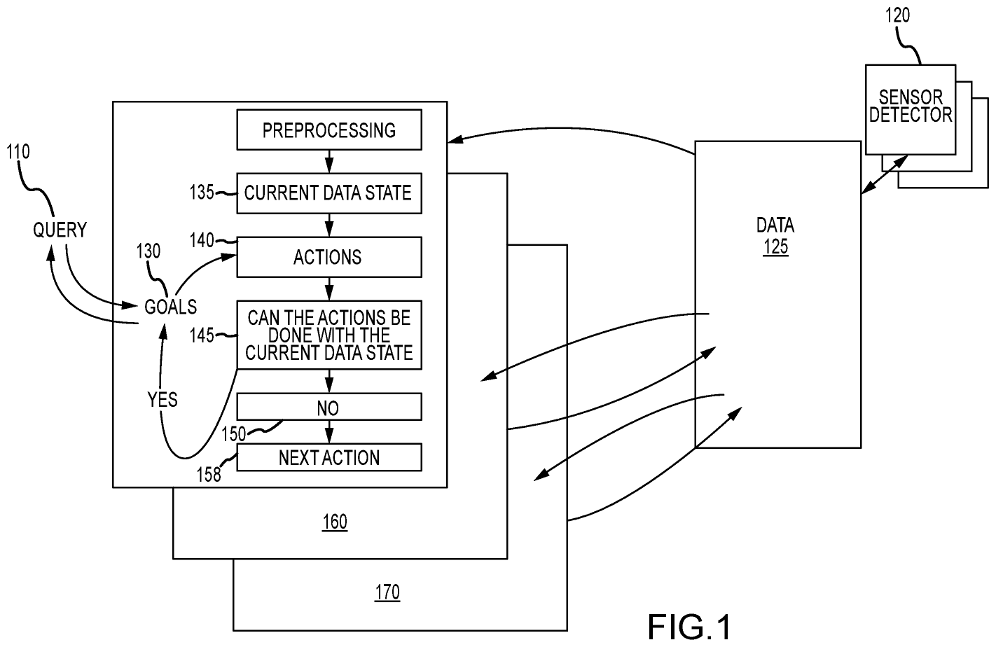

A hierarchical structure of intelligent agents parses and resolves an inquiry using an established protocol and predetermined processes. According to one embodiment of the present invention and with reference to FIG. 1, a received request or inquiry 110 is deconstructed based on a predetermined protocol. The agent(s) is(are) communicatively coupled to a database or data repository. Sensors 120 or detectors of various types capture and house data 125 relevant to a particular examination. Upon receipt of an inquiry 110 regarding data, the protocol(s) provides a framework by which to interpret the question and identify elements that, when determined and added together, resolve the inquiry.

Deconstructing the query into sub-questions based on predetermined protocols, the invention identifies what information is necessary and what steps 130 (goals) need to be undertaken to respond to the query. If 145 the actions 140 can take place using the current state of the data 135, then a response is generated, and output reported. If the one or more of the actions cannot be completed 150 with the data in its current state, the invention seeks 155 assistance of other intelligent agents 160, 170. In doing so the deconstruction agent assigns each sub-question or action to one or more primary intelligent agents 160. The primary agent 160 examines the database possessing data of interest and determines whether the current state of the data is sufficient to resolve the sub-question. When the answer is yes, the primary agent produces and returns to the database and deconstruction agent an output in response to the request.

When the current state of data lacks information needed to resolve the sub-question, the primary agent 160 engages one or more secondary agents 170. Each of these agents are tasked to develop or generate necessary material to resolve that which has been identified as lacking by the primary agent 160. Should the secondary agent 170 also determine that the current state of data is inadequate for it to compete its task, it too can seek additional agents, tertiary agents, to generate material so that the secondary agent can generate its material in response to the primary agent's request.

As agents produce additional material in response to a need identified by a superior agent, the output is placed in a common data repository 125. Each agent monitors the data repository for material sufficient for it to complete its assigned question. Upon an inferior agent adding new material to the database (data repository) the superior agent recognizes the inclusion and works on its assigned task. Ultimately, the hierarchal structure provides sufficient information within the database for generation of a responsive output to the original query.

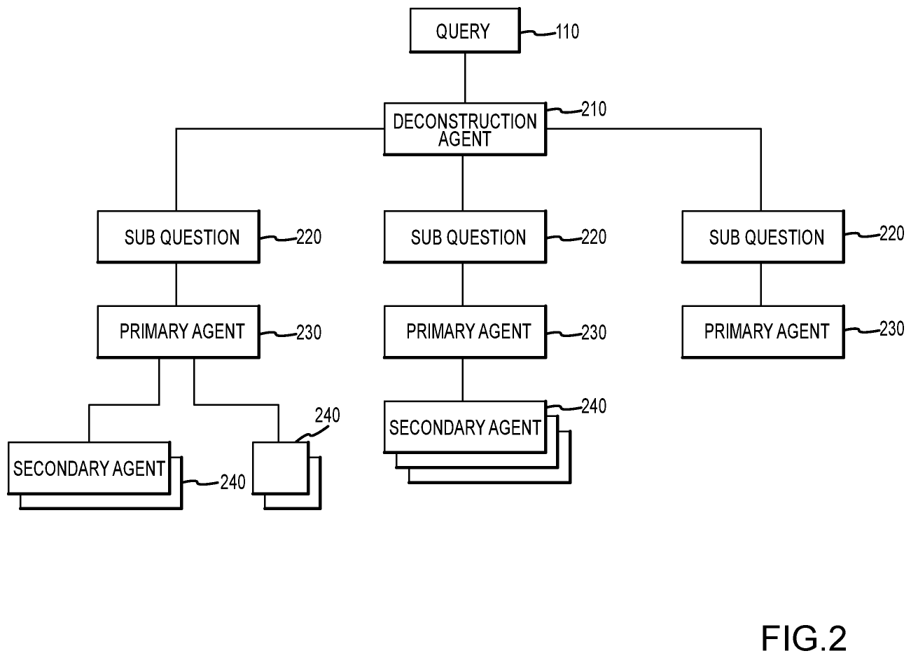

FIG. 2 provides a high-level view of the hierarchical nature of the present invention. The deconstruction agent 210 parses a query 110 into one or more sub-question 220. Upon recognizing that information in the database is insufficient to resolve each of the sub-questions and thus the query, the deconstruction agent turns to one or more primary agents 230 which in turn can seek the assistance of one or more secondary agents 240, and so forth. While tasked by a superior agent, each is coupled to a common database in which it places its output.

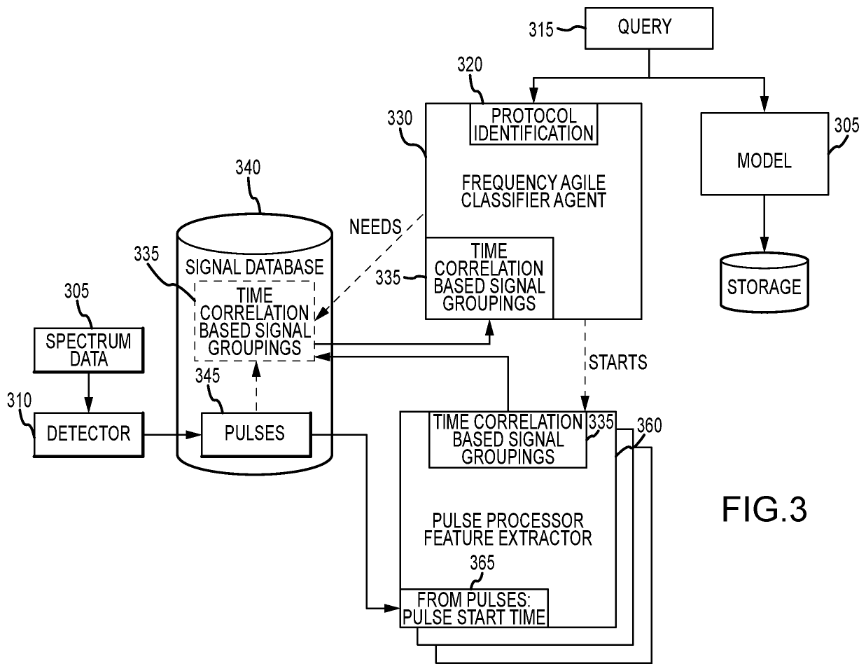

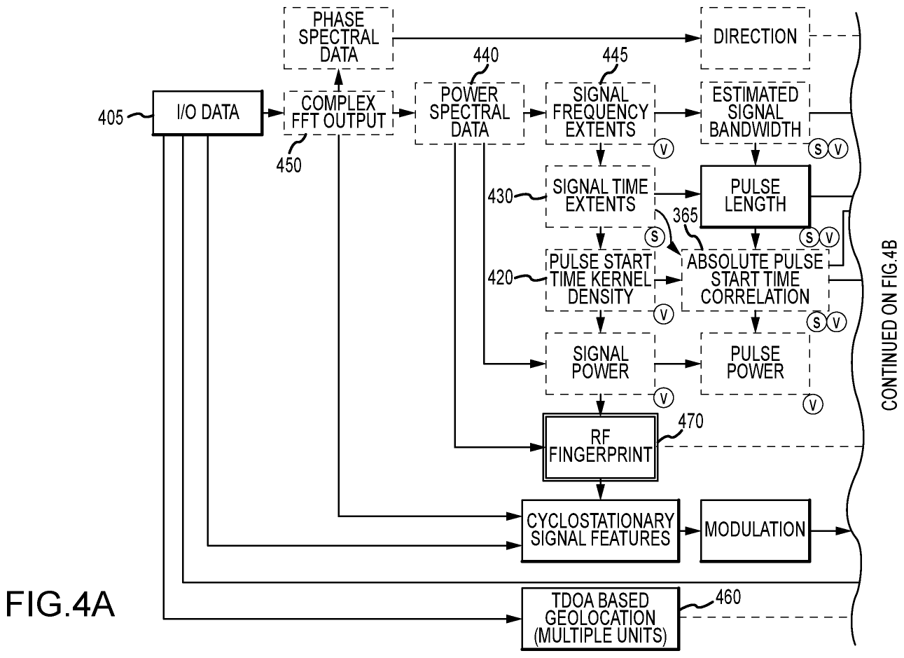

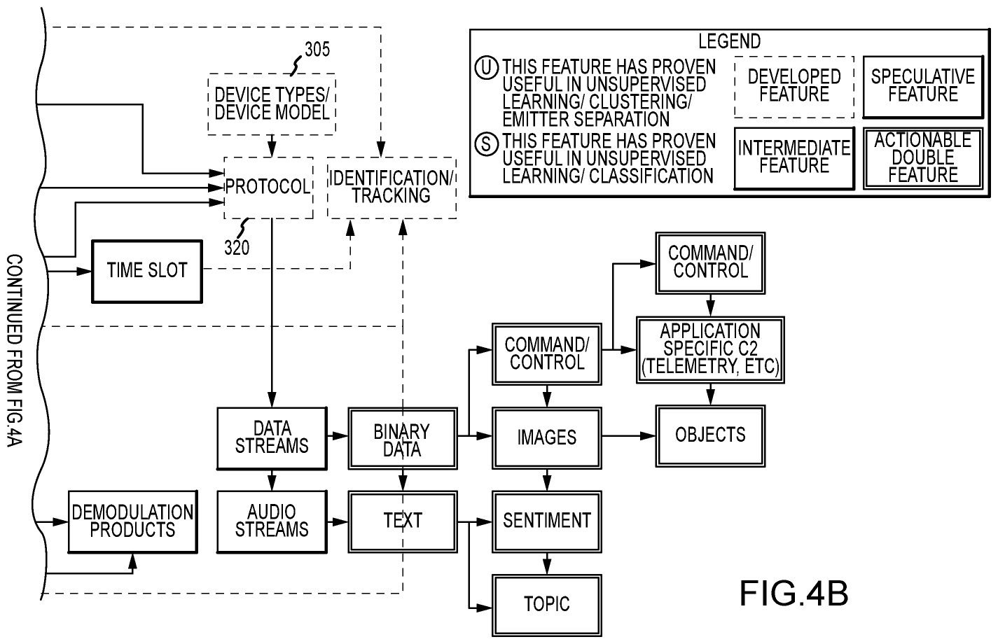

To more fully understand the implementation of the present invention, consider the following example, illustrated in FIGS. 3 and 4. The detection of actionable signals in the Radio Frequency spectrum is a challenge. Frequency agile systems are difficult to detect and, even when detected, difficult to classify and identify.

According to one embodiment of the present invention the artificial intelligent agents of the present invention automatically detects signals, extracts them, puts them into a database and then accesses that database to provide relevant and actionable information. The intelligent agents described below rapidly assembles the pieces needed to provide relevant decision support information such as is a signal detected, where and when was the signal detected, what class of signal is it, and what vehicles are associated with that signal.

Assume a query is issued seeking to determine if a certain class of frequency agile Unmanned Aerial Vehicles (UAVs) are operating in a certain location. The pervasive use of UAVs has led to technical and societal concerns related to security, privacy, and public safety which must be addressed. For example, a UAV interrupted a US Open tennis match, and another crashed at the White House. One means by which to detect a UAV is by sensing the radio frequency spectrum by which it operates.

Sensors 310 or similar collection means gather data 305 that may otherwise resemble noise. Indeed, some frequency agile systems are designed to resemble noise thereby making detection challenging. Frequency agile systems, for example, can “hop” to another frequency at a rate exceeding 80000 hops per second.

In such a system, spectrum accumulation and statistical fingerprint analysis techniques, or models 305, are used to provide frequency estimates of RF signals. These estimates can be used to determine if a UAV is present in the detection environment. Predetermined protocols such as these establish what sort of information is needed to determine if a UAV is present and thus respond to the query.

While the data collected by sensors 350 may possess sufficient data it may not be in the form that is useable. Thus, when a query 315 is issued, “Is a frequency agile UAV operating in a certain region of interest”, it must be parsed into resolvable and actionable sub-questions.

The invention parses the question into actionable sub-questions using protocols such as, among other things, “Within the detected data, are there groupings of time correlated signals”. To answer the query, the agent may need to examine pulse lengths, signal bandwidth, pulse power and the like as well as conduct a multilateration analysis to identify a geospatial location of the signals. A response from each of a plurality of sub-questions leads to a resolution of the original query. Assume in this example and according to one embodiment of the present invention, that one sub-question is assigned to a primary agent, such as a classifier or frequency agile classification agent 330, to identify time correlated grouped signals.

The classifier agent 330, using the predetermine protocols 320, recognizes that time correlated grouped signals 335 are indicative of a frequency agile system. The agent therefore needs, and seeks, to determine whether the signal database 340 includes time correlated grouped signals.

Assuming for this example that the spectrum data 305 detected and stored in the database 340 are pulses 345 and not time correlated. The classifier agent 330 (the primary agent) does not identify data within the database 340 to resolve the sub-question. It issues a request to a secondary agent, a pulse processor feature extractor 360 (a secondary agent), to generate time correlated grouped signals 335 based on detected pulse start time information present in the database.

The protocols of the frequency agile classifier agent recognize that from pulse start times 365 it can determine time correlation-based signal groupings 335. The agent examines the database 390 to find pulse information 345 but fails to find the pulse start times 410 in the database. Using known protocols, a secondary agent is initiated seeking pulse start time kernel densities 420 and signal time extents 430 with which it can determine pulse start times. While pulse start time kernel densities 420 can be derived from the signal time extents 430, the signal time extents must be derived from power spectral data 440, and Signal Frequency Extents 445 which is an output of a complex Fast Fourier Transform 450.

Working backward with a plurality of agents, a complex FFT 450 modifies the original data 405 to generate power spectral data 440 which in turn feeds the generation of, among other things, signal time extents 430. The signal time extents 430 are the basis of another agent's generation of pulse start time kernel density data 425 which, when combined with the signal time extents 430, forms pulse start time correlations 365.

The database now includes pulse start times which the pulse processor feature extractor 360 can use to generate time correlation-based signal groupings 335. These groupings are generated and placed in the database 340. Upon the involvement of several inferior agents, the primary classifier agent 330, has the needed information in the database 340, time correlation-based signal groups 335, by which it can return to the deconstruction agent a response to the question, “Have frequency agile signals been detected”. This response combined with other information such as geolocation, TDOA 460, and RF fingerprints 470 can be combined to output a response to the initial query, “Is a frequency agile UAV operating in a certain region of interest?”

Each agent monitors a common database for information needed for its assigned task. Upon another agent providing such information into the database, the agent awaiting such information proceeds to produce its assigned output.

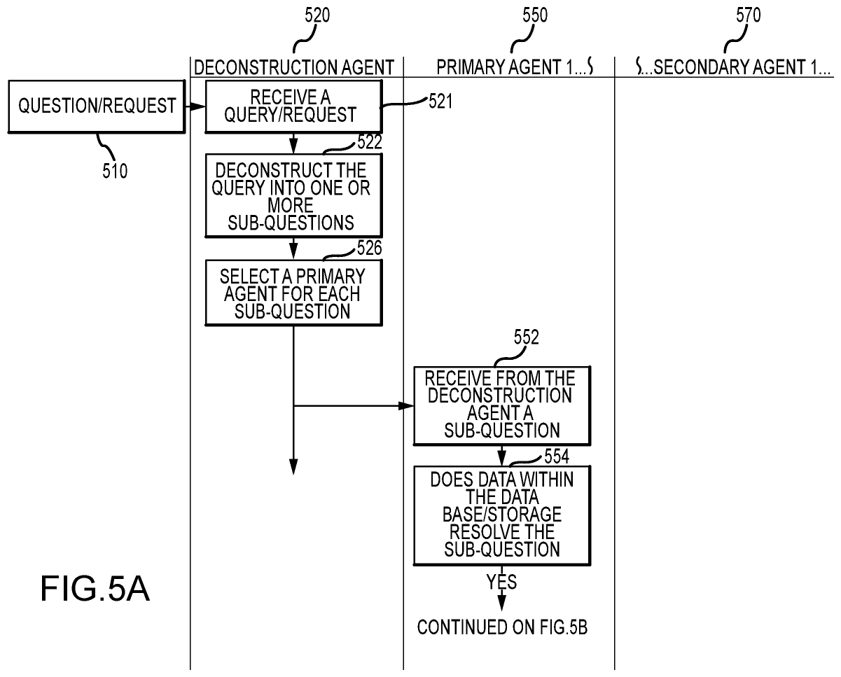

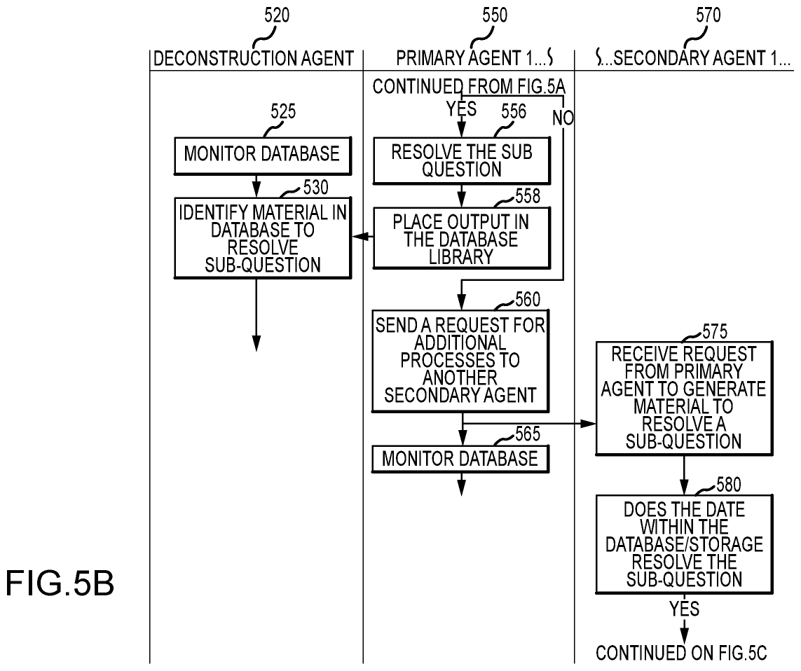

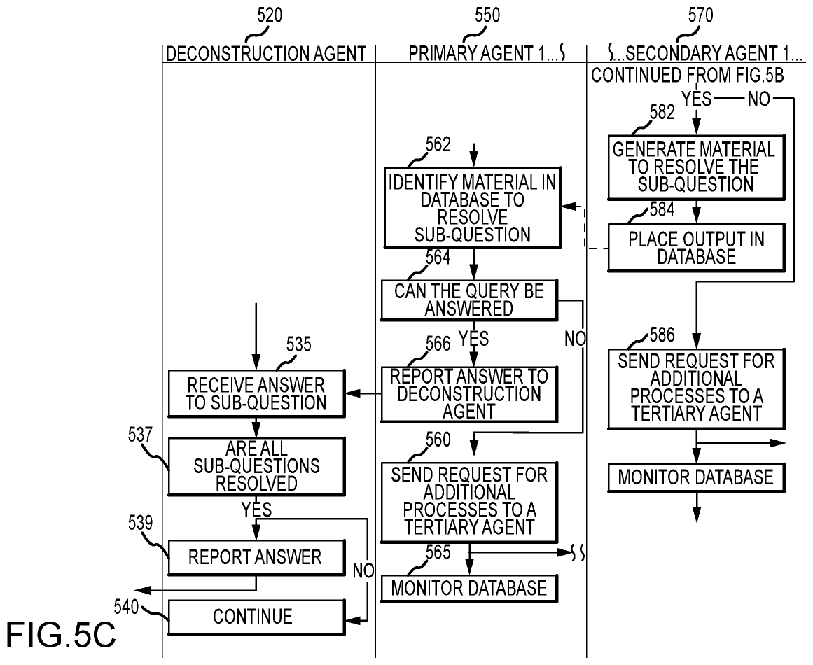

FIG. 5 presents a communication flowchart of a methodology for AI guided spectrum operations, according to one embodiment of the present invention. Upon the receipt 521 of a query 510 or request for information, the deconstruction agent 520 parses 522 the question into sub-questions based on predetermined protocols. For each sub-question a primary agent is selected 526 and assigned. Note that FIG. 5 reflects the interaction of the deconstruction agent 520, a single primary 550 and single secondary 570 agent. The deconstruction agent 520 may, as it parses 522 the original request, engage multiple primary agents 550, who in turn may engage multiple secondary agents 570 to resolve each sub-question 530. FIG. 5 is therefore illustrative of a general process that may be scaled throughout a hierarchal structure and is not limiting in its presentation.

Turning back to FIG. 5, upon a primary agent 550 receiving 552 its assigned sub-question it ascertains 554 whether the database or data repository possesses adequate information to resolve the received question/request. When the response to such an investigation is yes, the requested material is generated 556 and placed 558 in the database. Should the answer to the question be no, the primary agent seeks assistance in gaining the material it needs to complete the assigned task.

To gain the necessary information the primary agent engages 560 a secondary agent with a specific request and thereafter monitors the database 565. For example, if the primary agent 550 recognizes that to respond to the request from the deconstruction agent 520, the database must have items A, B and C. However, upon its examination of the database it finds only items A and B are present. Using predetermine protocols it knows that a particular secondary agent can produce item C and thus it sends a request to this secondary agent 570 for items C.

The secondary agent 570, much like the primary agent 550, examines the database to determine whether the database possesses the necessary material for it to respond to the primary agent's request 580. If sufficient information is present in the database, the secondary agent 570 generates 582 the requested material and places 584 it in the database. Recall that the primary agent 550 continually monitors 565 the database for its needed information. In this example, item C. Upon the secondary agent's 570 generation 582 of item C and placement 584 into the database, the primary agent 550 will recognize 562 the availability of item C and combine it 564 with items A and B to complete its pending task.

When the primary agent 550 resolves 564 its sub-question, it places the requested data/answer in the database. Upon the deconstruction agent 520, receiving the response 535 each sub-question 537 answer is generated 539 and reported. The process continues 540 until all sub-questions are resolved.

Should the secondary agent 570 find that the database lacks information for it to produce the desired material, it too can seek 586 the services of a tertiary agent. In the same manner other primary and secondary agents work in hierarchal, but parallel, fashion to resolve the initial query and product an actionable output.

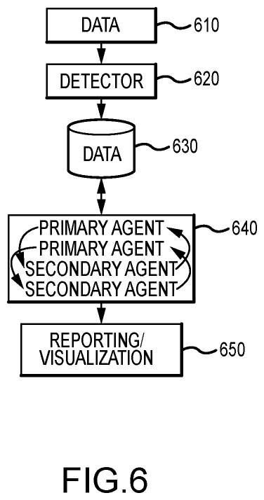

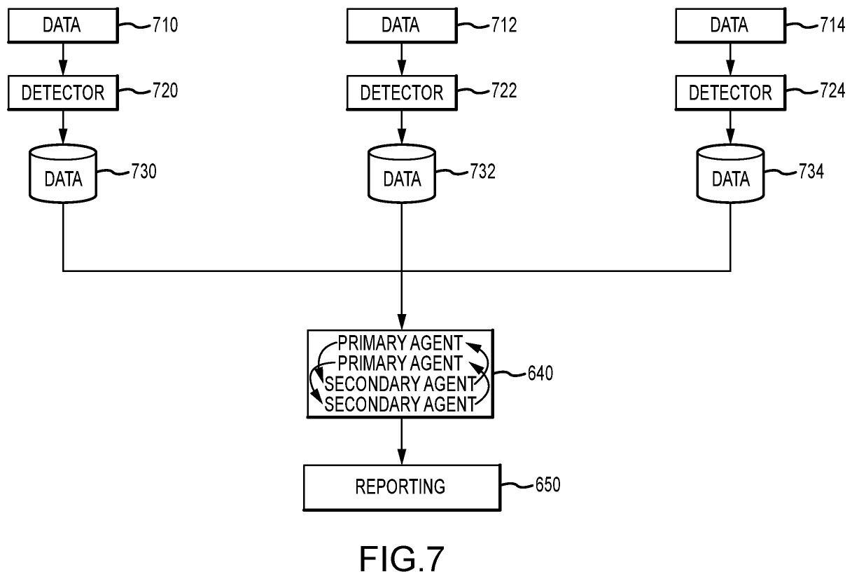

FIGS. 6 and 7 present high-level architecture instances of the present invention in a singular and a networked environment. In a typical implementation, as illustrated in FIG. 6, one or more sensors collects data 610 that is thereafter detected 620 and placed in a data repository/database 630. Upon gaining an inquiry, one or more agents 640 are engaged to examine the data and provide a report or desired visualization 650 of the detected information. FIG. 6 presents two primary and two secondary agents, however one of reasonable skill in the relevant art will recognize that the depiction is merely illustrative.

In another embodiment of the present invention the agents 640 need not be collocated with the data 710, 712, 714 or with other agents. The system can be scaled to engage multiple sensor and detector 720, 722, 724 platforms as well as multiple databases 730, 732, 734 which each of the primary and secondary agents 640 can access. The data consumed by one agent can be contributory for another thereby enhancing the decision-making capability of the present invention. The present invention engages a constantly evolving data picture so as to produce current actionable results 650.

In a preferred embodiment, the present invention can be implemented in software. Software programming code which embodies the present invention is typically accessed by a microprocessor from long-term, persistent storage media of some type, such as a flash drive or hard drive. The software programming code may be embodied on any of a variety of known media for use with a data processing system, such as a diskette, hard drive, CD-ROM, or the like. The code may be distributed on such media or may be distributed from the memory or storage of one computer system over a network of some type to other computer systems for use by such other systems. Alternatively, the programming code may be embodied in the memory of the device and accessed by a microprocessor using an internal bus. The techniques and methods for embodying software programming code in memory, on physical media, and/or distributing software code via networks are well known and will not be further discussed herein.

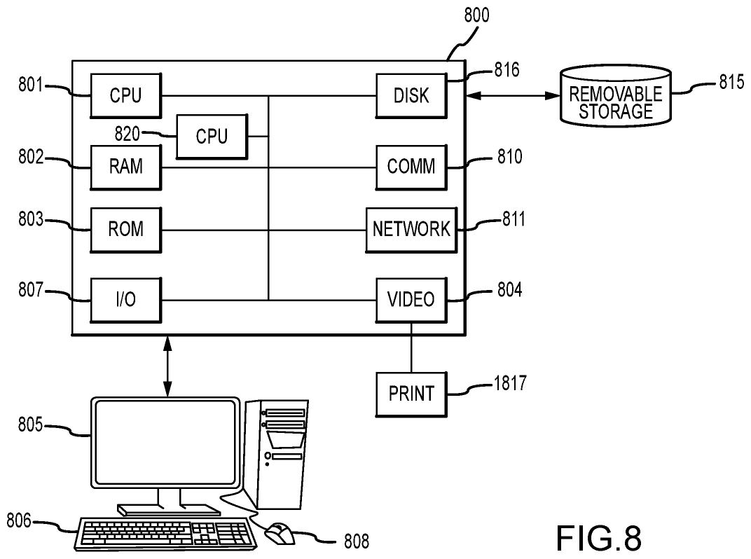

One of reasonable skill will also recognize that portions of the present invention may be implemented on a conventional or general-purpose computer system, such as a personal computer (PC), server, a laptop computer, a notebook computer, a handheld or pocket computer, and/or a server computer. FIG. 8 is a very general block diagram of a computer system in which software-implemented processes of the present invention may be embodied. As shown, system 800 comprises a central processing unit(s) (CPU) or processor(s) 801 coupled to a random-access memory (RAM) 802, a graphics processor unit(s) (GPU) 820, a read-only memory (ROM) 803, a keyboard or user interface 806, a display or video adapter 804 connected to a display device 805, a removable (mass) storage device 815 (e.g., floppy disk, CD-ROM, CD-R, CD-RW, DVD, or the like), a fixed (mass) storage device 816 (e.g., hard disk), a communication (COMM) port(s) or interface(s) 810, and a network interface card (NIC) or controller 811 (e.g., Ethernet). Although not shown separately, a real time system clock is included with the system 800, in a conventional manner.

CPU 801 comprises a suitable processor for implementing the present invention. The CPU 801 communicates with other components of the system via a bi-directional system bus 820 (including any necessary input/output (I/O) controller 807 circuitry and other “glue” logic). The bus, which includes address lines for addressing system memory, provides data transfer between and among the various components. Random-access memory 802 serves as the working memory for the CPU 801. The read-only memory (ROM) 803 contains the basic input/output system code (BIOS)—a set of low-level routines in the ROM that application programs and the operating systems can use to interact with the hardware, including reading characters from the keyboard, outputting characters to printers, and so forth.

Mass storage devices 815, 816 provide persistent storage on fixed and removable media, such as magnetic, optical, or magnetic-optical storage systems, flash memory, or any other available mass storage technology. The mass storage may be shared on a network, or it may be a dedicated mass storage. As shown in FIG. 8, fixed storage 816 stores a body of program and data for directing operation of the computer system, including an operating system, user application programs, driver and other support files, as well as other data files of all sorts. Typically, the fixed storage 816 serves as the main hard disk for the system.

In basic operation, program logic (including that which implements methodology of the present invention described below) is loaded from the removable storage 815 or fixed storage 816 into the main (RAM) memory 802, for execution by the CPU 801. During operation of the program logic, the system 800 accepts user input from a keyboard and pointing device 806, as well as speech-based input from a voice recognition system (not shown). The user interface 806 permits selection of application programs, entry of keyboard-based input or data, and selection and manipulation of individual data objects displayed on the screen or display device 805. Likewise, the pointing device 808, such as a mouse, track ball, pen device, or the like, permits selection and manipulation of objects on the display device. In this manner, these input devices support manual user input for any process running on the system.

The computer system 800 displays text and/or graphic images and other data on the display device 805. The video adapter 804, which is interposed between the display 805 and the system's bus, drives the display device 805. The video adapter 804, which includes video memory accessible to the CPU 801, provides circuitry that converts pixel data stored in the video memory to a raster signal suitable for use by a cathode ray tube (CRT) raster or liquid crystal display (LCD) monitor. A hard copy of the displayed information, or other information within the system 800, may be obtained from the printer 817, or other output device.

The system itself communicates with other devices (e.g., other computers) via the network interface card (NIC) 811 connected to a network (e.g., Ethernet network, Bluetooth wireless network, or the like). The system 800 may also communicate with local occasionally connected devices (e.g., serial cable-linked devices) via the communication (COMM) interface 810, which may include a RS-232 serial port, a Universal Serial Bus (USB) interface, or the like. Devices that will be commonly connected locally to the interface 810 include laptop computers, handheld organizers, digital cameras, and the like.

As will be understood by those familiar with the art, the invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which is set forth in the following claims.

While there have been described above the principles of the present invention in conjunction with AI spectrum operations, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features that are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserves the right to formulate new claims to such features and/or combinations of such features during the prosecution of the present application or of any further application derived therefrom.

1. A system for intelligent spectrum operations, comprising:
a deconstruction agent configured to receive a question and parse the question into one or more sub-questions based on a predetermined protocol
one or more primary agents wherein the deconstruction agent selects one of the one or more primary agents for each sub-question and wherein the primary agent is configured to monitor a database to identify information in the database resolving the sub-question and, responsive to information in the database being inadequate to resolve the sub-question, the primary agent is configured to send a request for additional processes to generate material lacking in the database yet needed to resolve the sub-question; and
a secondary agent configured to receive the request to generate the material to resolve the sub-question, whereby the secondary agent is configured to generate an output responsive to the sub-question and request and place the output in the database, and wherein the deconstruction agent, the primary agent and the secondary agent are each embodied as instructions in the form of software, stored on a non-transitory storage medium and executable by a processor.

2. The system for intelligent spectrum operations according to claim 1, wherein the secondary agent receives the request from the primary agent.

3. The system for intelligent spectrum operations according to claim 1, wherein the secondary agent generates the output using processes based on the predetermined protocol.

4. The system for intelligent spectrum operations according to claim 1, wherein the deconstruction agent is a primary agent.

5. The system for intelligent spectrum operations according to claim 1, wherein the primary agent is a classification agent.

6. The system for intelligent spectrum operations according to claim 5, wherein the classification agent is configured to translate input variables based on the predetermined protocol.

7. The system for intelligent spectrum operations according to claim 1, wherein the secondary agent is a feature extraction agent

8. The system for intelligent spectrum operations according to claim 7, wherein the feature extraction agent is configured to conduct a mathematical or algorithmic process to generate the output.

9. The system for intelligent spectrum operations according to claim 1, wherein the secondary agent can be a classification agent.

10. The system for intelligent spectrum operations according to claim 1, wherein the secondary agent is configured to monitor the database in search of information need to resolve the sub-question and responsive to information in the database being inadequate, the secondary agent is configured to request additional processes to generate additional material to resolve the sub-question.

11. The system for intelligent spectrum operations according to claim 1, wherein the secondary agent uses digital signal processing to generate the output.

12. The system for intelligent spectrum operations according to claim 1, wherein the secondary agent uses statistical and unsupervised means to generate the output.

13. The system for intelligent spectrum operations according to claim 1, wherein the system is a self-organizing top-down architecture to achieve intermediate stages to meet the request with the output

14. A method for intelligent spectrum operations, implemented by a computer wherein the computer includes one or more processors configured to execute instructions stored on a non-transitory storage medium to perform the method, the method comprising:
by a deconstruction agent, receiving and parsing a question into one or more sub-questions based on a predetermined protocol and thereafter selecting one of one or more primary agents for each sub-question;
by the selected one or more primary agents, monitoring a database to identify information in the database resolving the sub-question and, responsive to information in the database being inadequate to resolve the sub-question, sending a request for additional processes to generate material lacking in the database yet needed to resolve the sub-question; and
by a secondary agent, receiving the request to generate the material to resolve the sub-question, generating an output responsive to the sub-question based and placing the output in the database.

15. A method for intelligent spectrum operations according to claim 14, wherein the secondary agent monitors the database in search of information need to resolve the sub-question and responsive to information in the database being inadequate requests additional processes to generate additional material to resolve the sub-question.

16. A method for intelligent spectrum operations according to claim 14, wherein the secondary agent monitors the database in search of information need to resolve the sub-question and responsive to information in the database being adequate resolves the sub-question placing additional material in the database.

17. A method for intelligent spectrum operations according to claim 14, wherein the secondary agent conducts a mathematical or algorithmic process to generate the material.

18. A method for intelligent spectrum operations according to claim 14, wherein generating the output, by the secondary agent uses processes based on the predetermined protocol.

19. A method for intelligent spectrum operations according to claim 14, further comprising using, by the secondary agent, statistical and unsupervised means to generate the output.

20. A method for intelligent spectrum operations according to claim 14, further comprising using, by the secondary agent, digital signal processing to generate the output.

21. A method for intelligent spectrum operations according to claim 14, further comprising translating input variables based on the predetermined protocol.
